(19) United States
(12) Patent Application Publication
(10) Pub. No.: US 2005/0027790 A1
(43) Pub. Date: Feb. 3, 2005

(54) System and method for an intelligent blotter engine

(76) Inventor: Alan Dziejma, Nashua, NH (US)

Correspondence Address: AKC PATENTS, 215 GROVE ST., NEWTON, MA, 02466, US

(21) Appl. No.: 10/900,219

(22) Filed: Jul. 27, 2004

Related U.S. Application Data
(60) Provisional application No. 60/490,571, filed on Jul. 28, 2003.

(51) Int. Cl. G06F 15/16

(52) U.S. Cl. 709/200

(57) ABSTRACT

The invention provides an intelligent blotter engine that allows a web server to deliver a static collection of data to a client computer while allowing the user to sort and select data locally. The technique consists of transmitting the information to be displayed in comma delimited form together with lists of Column Headings, Column Formats, method of Sorting for each column, Message to be displayed when mouse passes over entry, and Initial Sort order for each column.

### CROSS REFERENCE TO RELATED CO-PENDING APPLICATIONS

This application claims the benefit of U.S. provisional application Ser. No. 60/490,571 filed on Jul. 28, 2003 and entitled SYSTEM AND METHOD FOR AN INTELLIGENT BLOTTER ENGINE, which is commonly assigned and the contents of which are expressly incorporated herein by reference.

### FIELD OF THE INVENTION

The present invention relates to a system and a method for an intelligent blotter engine, and more particularly to an intelligent blotter engine that allows a web server to deliver a static collection of data to a client machine via a network connection while allowing the user to sort and select data locally in the client machine.

### BACKGROUND OF THE INVENTION

Typically a web based distributed computing system includes a server and several client machines that connect to the server via a network connection. The server stores data and runs web applications and the client machine accesses these data and the web applications via the network connection. A user enters a request to run a web application or to download data into a user interface field displayed through the web browser of the client machine. The server receives the request, executes the requested web application and transmits the results of the web application and the requested data through the network to the client machine. The data and the results of the web applications are transmitted as Hypertext Markup Language (HTML) web pages. This process is time consuming, inefficient and requires a large bandwidth.

Frequently, the user receives the data in the client machine and wishes to view the data in a different format or to search and select data based on certain criteria. Current web based computing systems do not allow the user to perform these operations on the local client machine. Instead, they transfer each request back to the server, run the requested task on the server and send the result back to the client machine. This is a very slow process, prone to errors, and requires a connection with a large bandwidth.

Accordingly, there is a need for a system that provides displaying and manipulating of data in a client machine without having to constantly go back to the server to accomplish these tasks and without requiring a network connection with a large bandwidth.

### SUMMARY OF THE INVENTION

The Intelligent Blotter Engine (IBE) is a computer application that allows a web server to deliver a static collection of data to a client computer while allowing the user to sort and select data locally in the client machine.

In general, in one aspect, the invention features a method of displaying data in a client machine of a distributed computing system that includes a server in addition to the client machine. The method includes connecting the client machine to the server via a network connection and downloading a static collection of the data and a code from the server to the client machine. The data comprise one or more rows of data in a coma delimited format and the code comprises executable instructions for generating a two dimensional electronic dashboard array and for arranging and displaying the one or more rows of data in the electronic dashboard array. The data and the code are stored in a memory of the client machine and the client machine executes the executable instructions thereby generating the electronic dashboard array and arranging and displaying the data in the electronic dashboard array.

Implementations of this aspect of the invention may include one or more of the following features. The code may further include executable instructions for manipulating the data in the electronic dashboard array via a user input through a user interface and displaying the result of the manipulated data in the electronic dashboard array. The code may be written using a combination of a markup language and an object-oriented programming language. The markup language may be a Hypertext Markup Language (HTML), HTML related markup languages, Extensible Markup Language (XML), XML related languages, XML User Interface Language (XUL), Scalable Vector Graphics (SVG), Xforms, text, or combinations thereof, and the object-oriented programming language may be Javascript, Java, J#, C#, C+, C++, Visual Basic, ActionScript, XSL, XQuery, or XPath. The method may further include login into the server via a secure login process, before downloading the set of data and the code. The manipulating of the data may comprise grouping, filtering, sorting in ascending and descending order, or combinations thereof. The executable instructions may comprise instructions for generating one or more columns, one or more column formats and one or more column headings, respectively, in the electronic dashboard array. The coma delimited formatted data define one or more columns of data and the one or more columns of data are arranged in the one or more columns of the electronic dashboard array, respectively. The code may further comprise instructions for displaying a message when a pointer points upon a field of the electronic dashboard array. The electronic dashboard array may further include a search field and the code may comprise instructions for receiving information entered into the search field and for performing a search based on the information. The information may be a keyword, a fragment of a keyword, a number, an alphanumeric character, a date, or a sign. The information may be entered by dragging and dropping information into the search field. The search comprises defining a two dimensional pointer array indicating columns and rows of the electronic dashboard array that contain the information.

In general, in another aspect, the invention features a distributed computing system comprising a client machine and a server. The client machine connects to the server via a network connections, downloads a static collection of data and a code from the server, stores the data and the code in a client machine memory and executes executable instructions comprised in the code thereby generating a two dimensional electronic dashboard array for arranging and displaying the data in the electronic dashboard array. The data comprise one or more rows of data in a coma delimited format.

Among the advantages of this invention may be one or more of the following. The Intelligent Blotter Engine (IBE) provides a dramatic reduction in the bandwidth requirement of the information flowing from the server to the client machine because HTML formatting is done on the client machine and not transmitted over the network. The IBE also provides a dramatic improvement in the apparent system responsiveness as seen by the user because large amounts of data are not required to be downloaded over the network for every selection or sort request that the user makes. The IBE also provides a dramatic reduction in the amount of HTML coding required on the part of developers since the IBE handles all cell formatting and “tool tip” display code. This allows programmers unskilled in distributed processing techniques to create applications that take advantage of distributed processing architecture.

### BRIEF DESCRIPTION OF THE DRAWINGS

FIG. 1 is a block diagram of a web based distributed computing system according to this invention;

FIG. 2 is an overview diagram of a business payment system (BPC™) that utilizes the Intelligent Blotter Engine (IBE) of this invention;

FIG. 3 is a screenshot of the login screen of the BPC™ system;

FIG. 4 is a screen shot of the implementation of the Intelligent Blotter Engine in the electronic dashboard of the BPC™ system as executed through the Microsoft Internet Explorer browser via an Internet connection;

FIG. 5 is a screen shot of the dashboard of the BPC™ system with the Select phrase “paid” indicating all paid transactions;

FIG. 6 is a screen shot of the dashboard of the BPC™ system with the Select Phrase “App” indicating all approved transactions;

FIG. 7 is a screen shot of the dashboard of the BPC™ system with the Select Phrase “11/10/2003” indicating all transactions having the date Nov. 10, 2003;

FIG. 8 is a screen shot of the dashboard of the BPC™ system with the Select Phrase “Randolph” indicating all transactions having the name Randolph;

FIG. 9 is a screen shot of the dashboard of the BPC™ system with the Select Phrase “nd” indicating all transactions that include the fragment “nd”;

FIG. 10 is a screen shot of the FIG. 9 grouped by Status; and

FIG. 11 is a screen shot of the FIG. 9 grouped by Seller;

### DETAILED DESCRIPTION OF THE INVENTION

This invention provides an innovative a system and a method for an intelligent blotter engine (IBE), and more particularly an intelligent blotter engine that allows a web server to deliver a static collection of data to a client machine while allowing the user to sort and select data locally in the client machine.

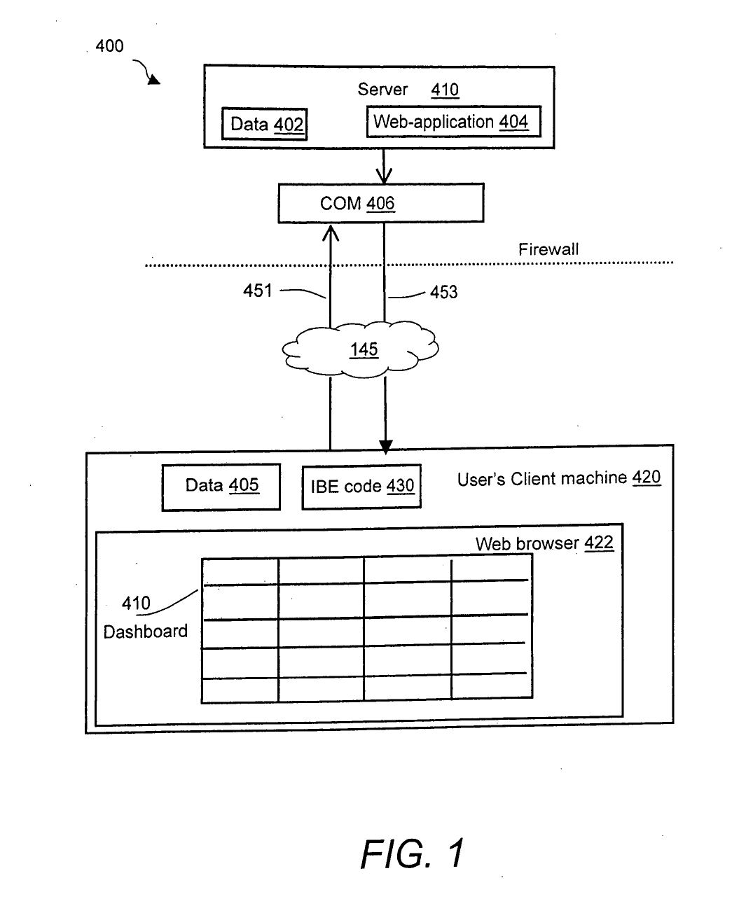

Referring to FIG. 1, the computing architecture of the IBE system 400 includes a user's client machine 420 connecting to a web server 410 via a network 145. Web server 410 includes data 402 stored in a database and a web application 404. Data 402 may be stored in any type of a database including Oracle, SQL, DB2, among others. A user accesses the web application 404 through a web browser 422 of the client machine 420 by entering a URL address pointing to the web application (451). The server 410 receives the URL request via the communication port 406 and requests a login identification name and a password. The user enters a login identification name and a password and the server 410 sends back a file containing a set of data 405 and a Javascript code 430 for generating a two dimensional electronic dashboard array 410 in the client machine 420 for displaying the data 405. Data 405 include only the segment of data 402 that the user is entitled to access based on previously set permission rules. Data 405 are transmitted to the user's client machine 410 as a static collection of rows of data having a coma delimited format, i.e., data separated by coma. An example of a data row having a coma delimited format is shown below:
[“1”,“C2028719”,“#93947-1291-3691”,“11/27/2003”,“16333.26”,“Palmer LLC”,“Yee International”,“Lynwood Lupo”,“(617) 244-8640 ext 364”,“(781) 977-7317”,“(781) 709-8627”]

In this example of a data row, eleven columns of data are specified. The server 410 may supply 1 to 1000 or more such data row definitions and 1 to 100 columns of input to the Intelligent Blotter Engine at one time.

In addition to the data 405, the server 410 provides the IBE code 430 containing instructions for generating the two dimensional dashboard array 410. These instructions include lists of Column Headings and lists of Column Formats. These inputs are illustrated below:

Sample Column Headings:
varheadings=[“Status”,“Control”,“P.O.Number”,“Date”,“Amount”,“Buyer”, “Seller”,“Acct Mgr”,“Buyer Phone”,“Seller Phone”,“Bank Phone”];

This Column Headings input to the Intelligent Blotter Engine specifies eleven column headings to be used for defining eleven columns of the dashboard 410, respectively. These eleven columns will accommodate the eleven columns of data shown in the previous example of the data row, respectively.

Sample Column Formats:
var format=[“,“,“,‘align=center’,‘dollar’,”,”,”];

This Column Formats input specifies the formats for displaying values in the columns. A format specification of ‘’ means values will be displayed as strings or numbers. ‘align=center’ means that values will be displayed centered in the column. ‘dollar’ means that values will be displayed with a $ and two digits of precision. For example, the fifth column depicting the “Amount” will be displayed with a $ sign and two digit precision. Accordingly, the fifth value of the previous data row example will be shown under the column heading of “Amount” as $16333.26. A valid HTML <td> format specification may be supplied as a Format specifier.

In addition to the formation of the two dimensional dashboard array 410, the IBE code provides a method of Sorting each column, a method for displaying a Message when a mouse passes over an entry field of the dashboard array, a method for an Initial Sort order for each column and a method for searching and filtering the data displayed in the two dimensional dashboard array 410.

Sample Sorting:
var sortKind=[‘n’,‘a’,‘a’,‘d’,‘$’,‘a’,‘a’,‘a’];

This Sorting input specifies the kind of data displayed in each column. ‘n’ means a number, ‘a’ means alphanumeric, ‘d’ means date, ‘$’ means dollar amount.

Sample Message:
var mouseo=[−1,−1,−1,−1,−1,8,9,10];

When the mouse pauses over an entry in a column, a small “tool tip” message is displayed based on these values. −1 means no message will be displayed. A value greater than −1 means the information from that column will be momentarily displayed.

Sample Initial Sort:
var sortOrder=[−1,1,1,1,1,1,1,1,1,1,1];

A −1 means the column will be sorted in reverse order initially. A 1 means the column will be sorted in normal order.

The IBE code uses the following functions to accomplish the above mentioned operations:
Function comma(n): This function takes a numeric value as input and returns a string with prepended dollar sign and comma inserted in the third digit position.
Function doSort(col,kind): This function takes a column number, the format of the column, and the current order of the column from the dashboard array order as input and performs the following kinds of sorts in ascending or descending order:
   alphabetic
   numeric
   date—where entries are parsed to permit correct handling of days such as 01 or 1, months such as 01 or 1, and years such as 03 or 2003
   $—where entries are parsed to accommodate $ signs
Function doDrop( ): This function allows the “drag and drop” of information into a search field.
Function showBlotter( ). This function is the primary display routine that selects user-requested rows from the available data using select results from previous searches to speed selection saving the results in a multidimensional array, calls doSort( ) to order the selected columns using the required data format, formats all requested columns of data according to the indicated column format parameters, and dynamically generates HTML in a local frame without server interaction.

Data 405 remain in a static array during all this processing. A pointer array is used to indicate which rows have met the selection criteria and a second pointer array is used to perform sorts. To speed selection as the user deletes letter from the search keyword, the selection array is actually a two dimensional array indicating the rows that meet the criteria at each letter of the keyword entry. A specific implementation of the IBE code in Javascript is depicted in Appendix A.

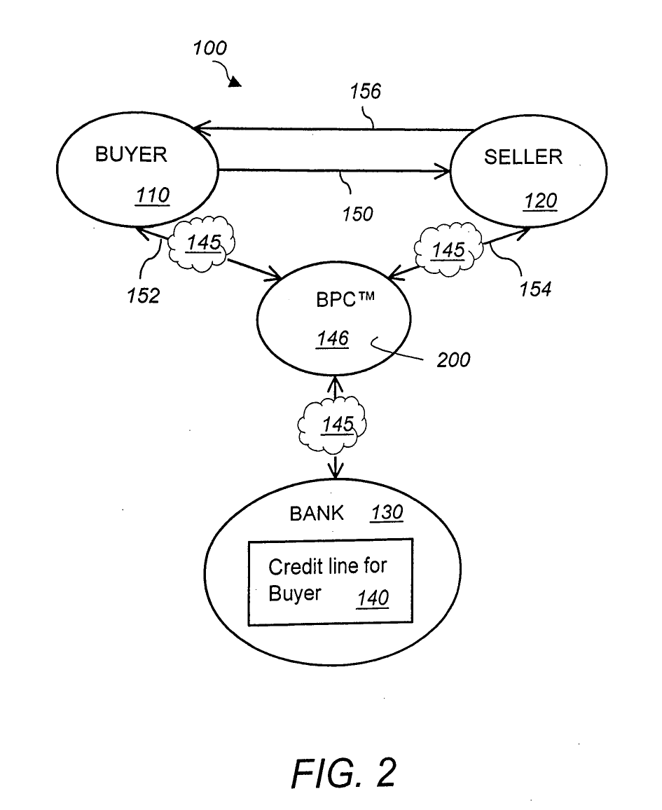

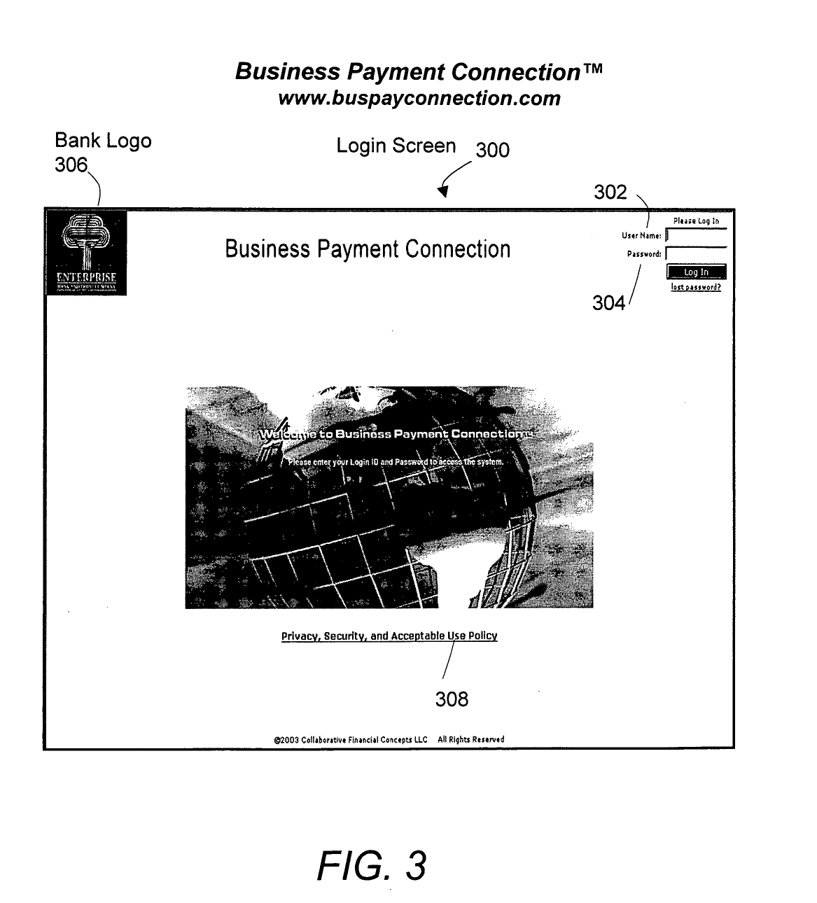

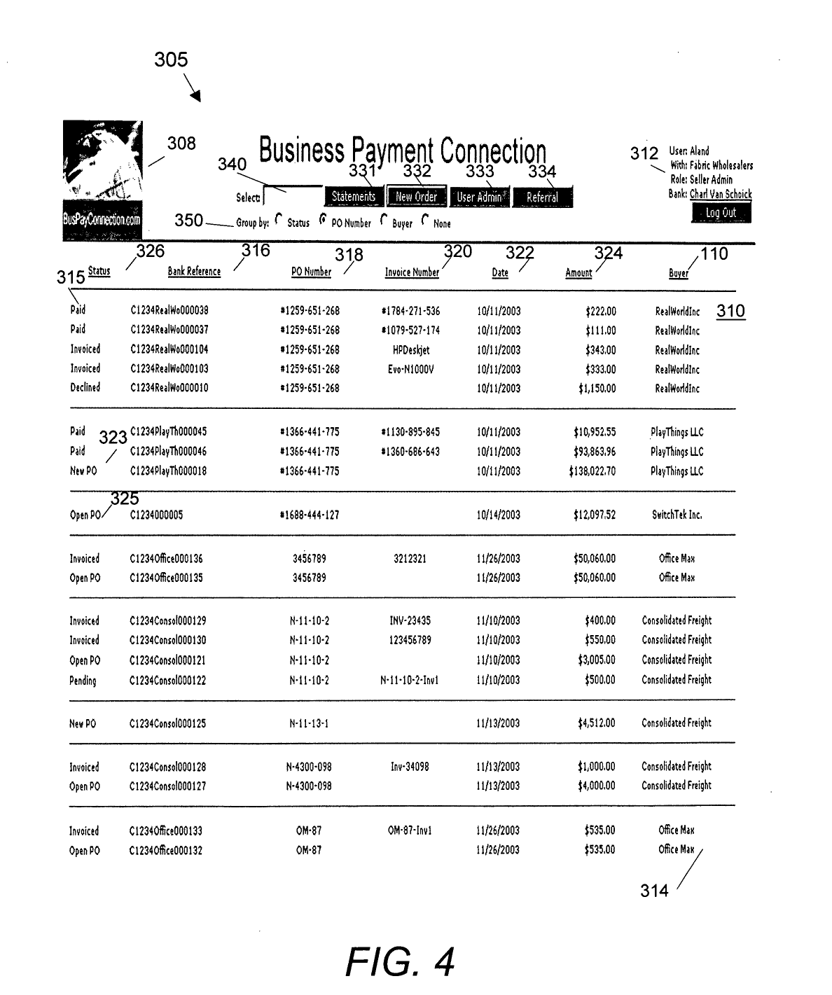

An application of the IBE computing architecture is implemented in connection with a distributed business payment system 100 described in a co-pending patent application entitled “System and method for a business payment connection” the contents of which are expressly incorporated herein by reference. Referring to FIG. 2, a distributed business payment system 100 includes a buyer 110, a seller 120 and a bank 130. The buyer 110 places a purchase order for a good or a service to the seller 120 (150). The purchase order is placed directly in a face-to face transaction. Alternatively, the order may be placed remotely, via the Internet, the phone or by mail. The seller 120, the buyer 110 and the bank 130 are connected via the Internet 145 to a web server 200. The bank 140 provides a credit line 140 to the buyer 110 and this credit line is used to pay the seller 120 for goods and services. The seller 120 receives the purchase order from the buyer 110 and then invoices the buyer 110 and ships the requested good or provides the service (156). The buyer 110 approves the invoice and instructs the bank 130 to pay the seller 120 via the previously arranged credit line 140 (152). The bank 130 pays the invoiced amount to the seller 120 after subtracting a transaction fee from the invoiced amount (154). This business payment process is facilitated by a Business Payment Connection™ (BPC™) application 146 stored in the web server 200. The BPC™ is accessed by the buyer 110, the seller 120, and the bank 130 via the Internet 145. The access can be direct by using the URL address “www.buspayconnection.com” through the Microsoft Internet Explorer web browser or through a link off the bank's website. By clicking on the link or the URL address a user accesses the BPC™ system's login screen 300, shown in FIG. 3. In order to login into the BPC™ system a user needs to enter a user identification name 302 and a password 304. A successful login leads to user interface screen 305, shown in FIG. 4. The user interface screen 305 contains an electronic dashboard array 310 and is the user's homepage for all activities. User interface screen 305 includes the user's name, the name of the user's company, the user's role and the name of the bank contact 312. User interface screen 305 provides a collaborative view of all transaction data for the buyer, seller and the bank. Dashboard 310 includes a two dimensional array of data displayed in rows 314 and columns 326, 316, 318, 320, 322, 324 and 110. Each row 314 displays data for a single transaction 315. The data for each transaction 315 are arranged in columns having headings including Status 326, a bank reference number 316, a PO number 318, an Invoice number 320, the name of the buyer 110 or the seller 120, the date of the transaction 322, and the amount 324. The PO number 318 is entered by the buyer 110, the invoice number 320 is entered by the seller 120, and the bank reference number is a unique transaction tracking code entered by the bank 130. The name of the buyer 110 or the name of the seller 120 is listed depending on who is looking at the screen, i.e., the buyer 110 views the names of the sellers 120 and the seller 120 views the names of the buyers 110. The status 326 of each transaction is identified as “paid”, “invoiced”, “declined”, “pending”, “open PO”, “cancel”, “closed”, “disputed”, “approved”, “stopped” or as “new PO”. These status codes help track purchase orders and invoice workflow. The status codes are changed to reflect the actions of the buyer 110, seller 120 or the bank 130. When a buyer 110 enters a new PO number the status code is changed to “new PO”. When the seller 120 sees the new PO number and accepts it the status is changed to “open PO”. When the seller 120 decides not to accept the PO the status is changed to “cancel”. When the seller 120 enters a new invoice against the entered PO number the status is changed to “invoiced” and when the invoice is processed against the PO number the status is changed to “closed”. When the buyer 110 has an issue with the invoice payment the status is changed to “disputed” and when the buyer 110 authorizes the bank 130 to pay the invoice the status is changed to “approved”. When the bank 130 approves the payment and makes the payment to the seller 120 the status is changed to “paid” and when the bank 130 has issues with the invoice payment the status is changed to “stopped”. User interface 305 also includes function buttons that bring up pop-up windows when a user clicks them. In one example, function buttons include “statements” 331, “new order” 332, “user administrator” 333, and “referral” 334. User interface 305 also includes a select field 340 and a “group by” function button 350. Select field 340 is used for quick transaction searches by a parameter such as PO number, invoice number, buyer's name, date, amount, status, or bank reference number. “group by” function buttons 350 include Status, PO number, and buyer and can group transactions 315 by clicking on the corresponding group by button 350.

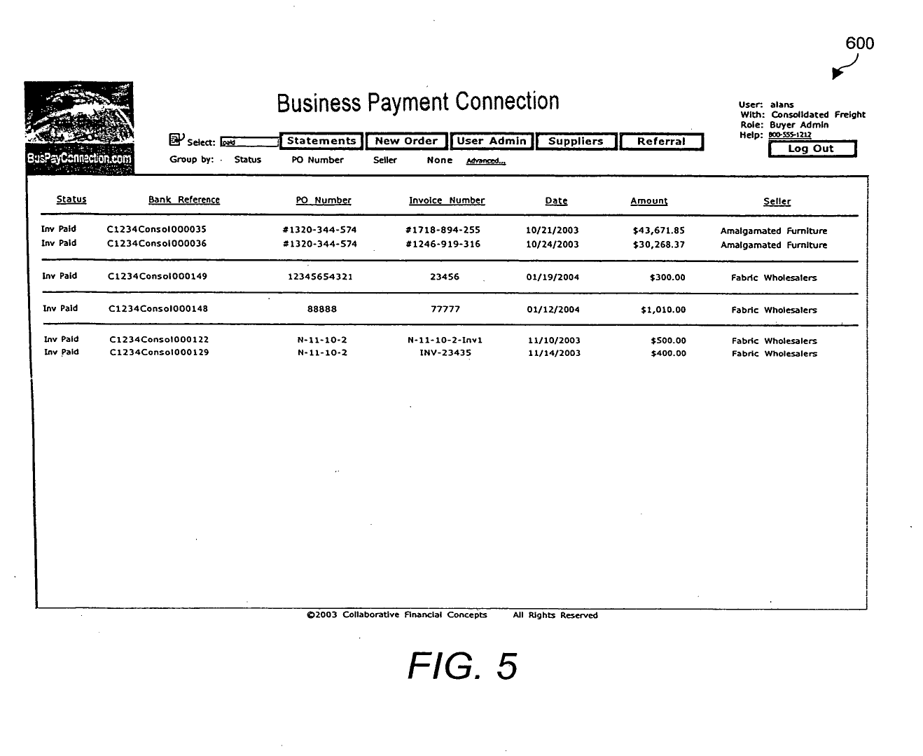

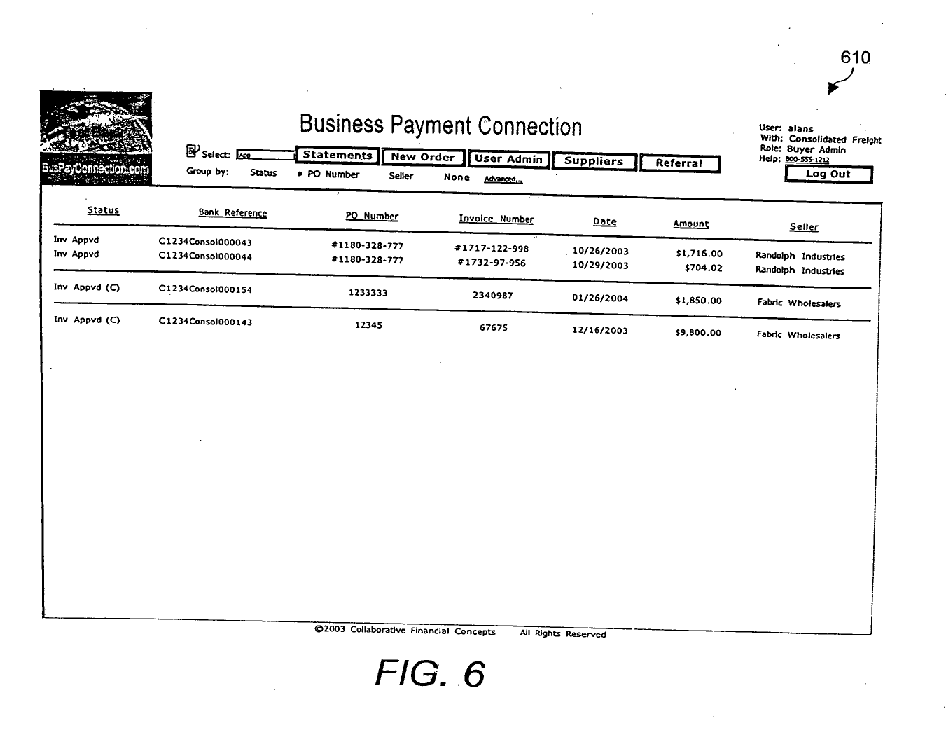

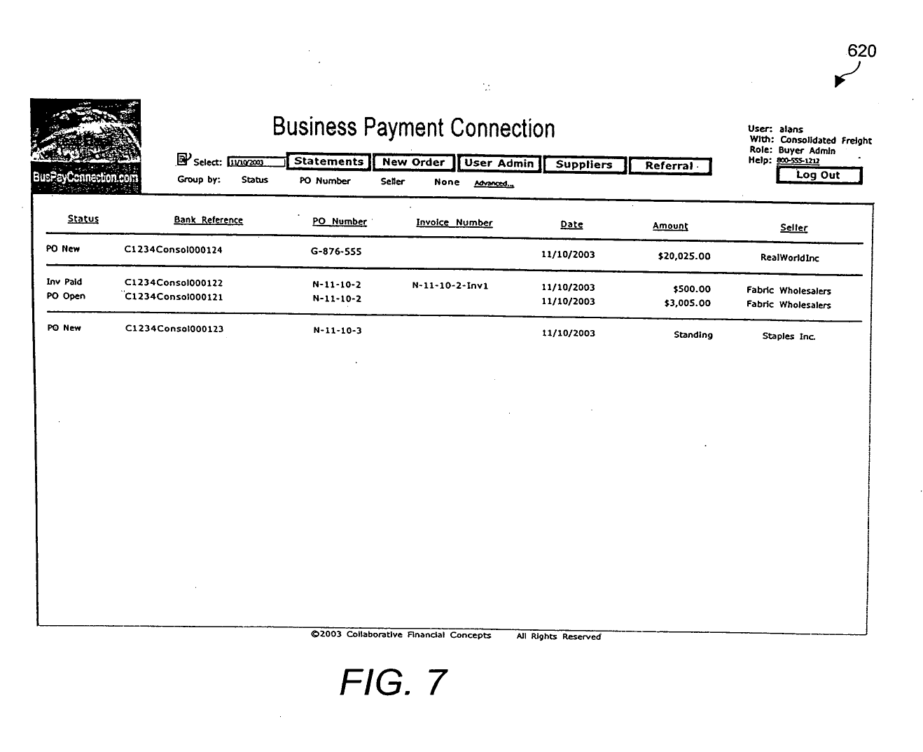

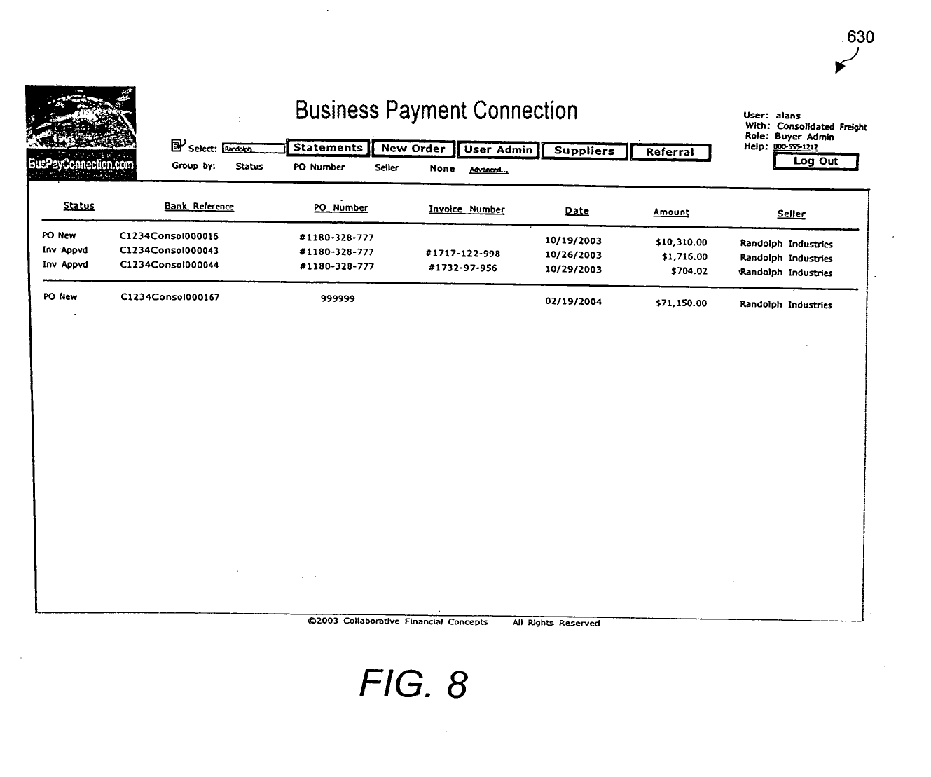

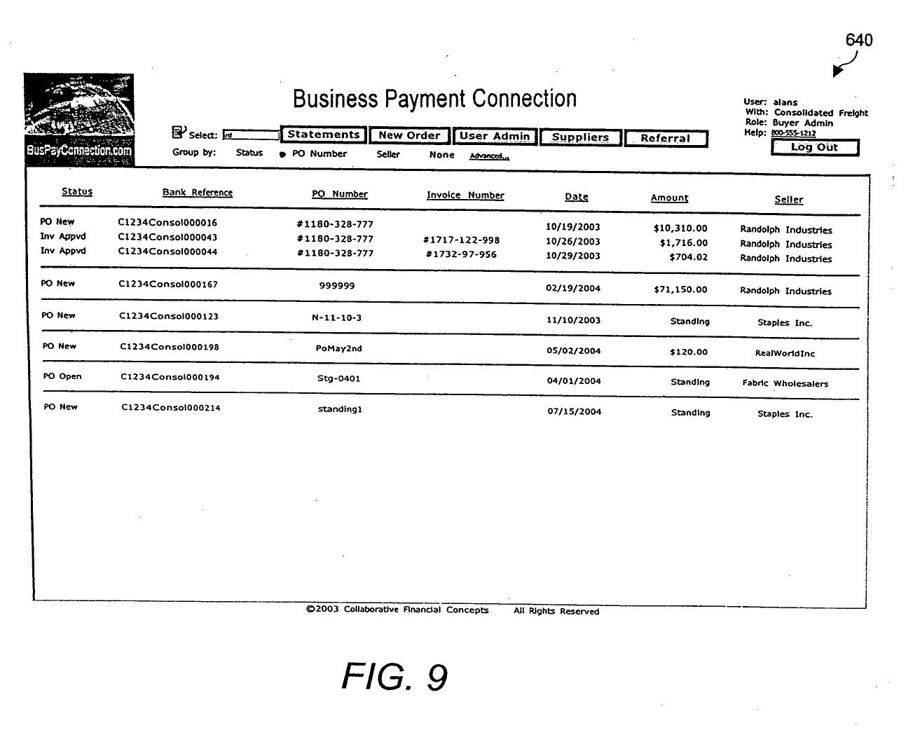

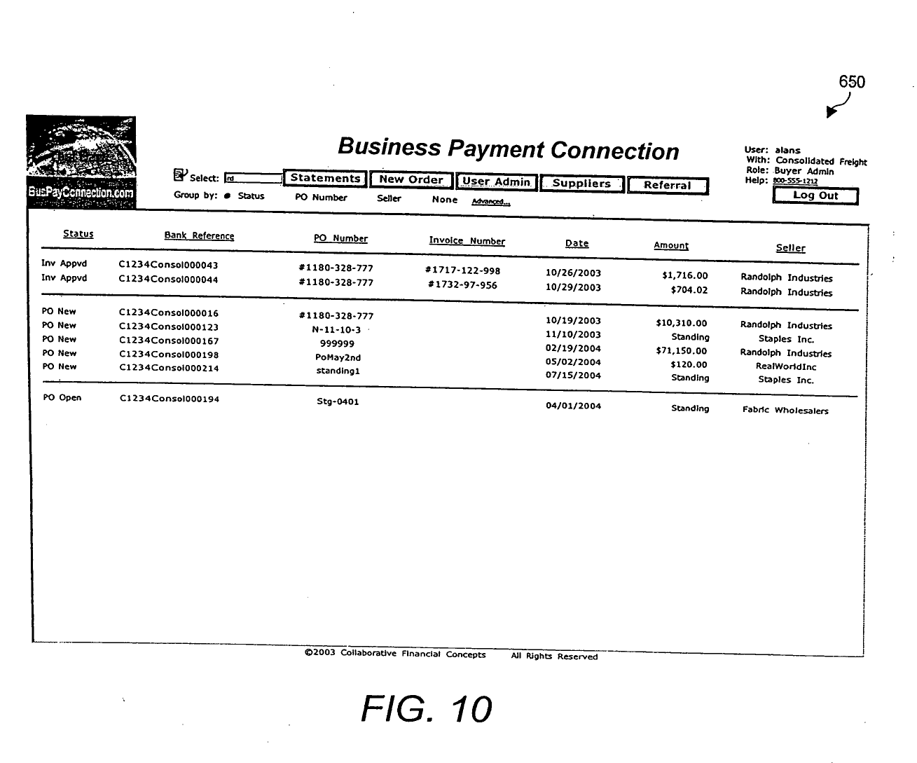

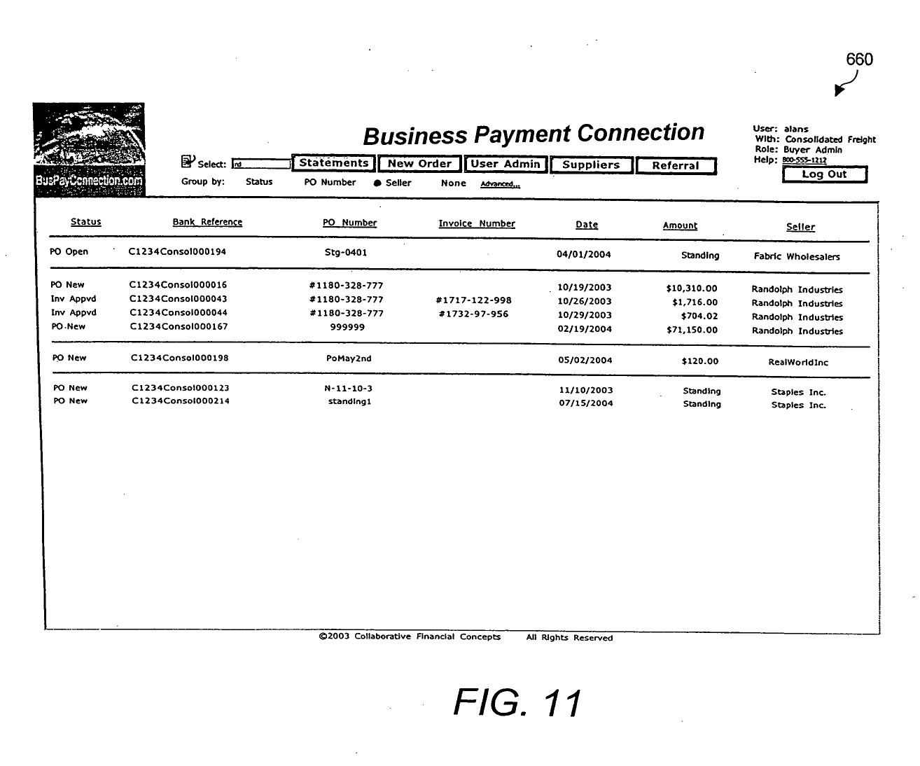

The implementation of the IBE provides the user with the ability to use the select field 340 to select and sort the transaction data 315 on the local client machine. The IBE also allows the use of the “group by” button 350 to group the static transaction data 314 by the PO Number, the buyer or the seller, depending on who is viewing the dashboard 310. FIG. 5 depicts a screen shot 600 of the dashboard 310 where the select phrase “paid” was entered to select all transactions that have a paid status. FIG. 6 depicts a screen shot 610 of the dashboard 310 where the select phrase “App” was entered to select all transactions that contain the keyword fragment “App”. FIG. 7 depicts a screen shot 620 of the dashboard 310 where the select phrase “11/10/2003” was entered to select all transactions that have a transaction date of Nov. 10, 2003. FIG. 8 depicts a screen shot 630 of the dashboard 310 where the select phrase “Randolph” was entered to select all transactions that have the Seller's name Randolph. FIG. 9 depicts a screen shot 640 of the dashboard 310 where the select phrase “nd” was entered to select all transactions that include the word fragment “nd”. These results are grouped by “P.O. Number”. FIG. 10 depicts the results of FIG. 9 grouped by “Status” 650. FIG. 11 depicts the results of FIG. 9 grouped by “Seller” 660. It should be noted that these searching and grouping processes occur very fast, following the entering of each character.

Other embodiments of this invention include the following. The IBE code may be written in any object-oriented programming language and in any markup language. The markup language may be HTML, HTML related markup languages, Extensible Markup Language (XML), XML related languages, XML User Interface Language (XUL), Scalable Vector Graphics (SVG), Xforms, text, or combinations thereof. The object-oriented programming language may be Java, JavaScript, J#, C#, C+, C++, Visual Basic, ActionScript, XSL, XQuery, or XPath. The IBE system may be used in connection with any type of applications including medical, government, financial, travel related systems, hotel reservation systems, and retail systems, among others. The IBE system may be combined with an inventory control system or an Enterprise Resource Management (ERP) system.

Several embodiments of the present invention have been described. Nevertheless, it will be understood that various modifications may be made without departing from the spirit and scope of the invention. Accordingly, other embodiments are within the scope of the following claims.

1. In a distributed computing system comprising a client machine and a server, a method of displaying data in said client machine comprising:
connecting said client machine to said server via a network connection;
downloading a static collection of said data and a code from said server to said client machine, wherein said data comprise one or more rows of data in a coma delimited format and said code comprises executable instructions for generating a two dimensional electronic dashboard array and for arranging and displaying said one or more rows of data in said electronic dashboard array;
storing said data and said code in a memory of said client machine; and
executing said executable instructions by said client machine thereby generating said electronic dashboard array and arranging and displaying said data in said electronic dashboard array wherein said electronic dashboard array and said displayed data are viewed through a user interface in said client machine.

2. The method of claim 1 wherein said code further comprises executable instructions for manipulating said data and said method further comprises manipulating said data in said electronic dashboard array via a user input through said user interface and displaying the result of said manipulated data in said electronic dashboard array.

3. The method of claim 1 wherein said code comprises executable instructions written using a combination of a markup language and an object-oriented programming language.

4. The method of claim 3 wherein said markup language is selected from a group consisting of a Hypertext Markup Language (HTML), HTML related markup languages, Extensible Markup Language (XML), XML related languages, XML User Interface Language (XUL), Scalable Vector Graphics (SVG), Xforms, text, and combinations thereof, and said object-oriented programming language is selected from a group consisting of Javascript, Java, J#, C#, C+, C++, Visual Basic, ActionScript, XSL, XQuery, and XPath.

5. The method of claim 1 further comprising login into said server via a secure login process, before downloading said set of data and said code.

6. The method of claim 2 wherein said manipulating of said data comprises operations selected from a group consisting of grouping, filtering, sorting in ascending and descending order, and combinations thereof.

7. The method of claim 1 wherein said executable instructions comprise instructions for generating one or more columns, one or more column formats and one or more column headings, respectively in said electronic dashboard array.

8. The method of claim 7 wherein said coma delimited form data define one or more columns of data and said one or more columns of data are arranged in said one or more columns of said electronic dashboard array, respectively.

9. The method of claim 1 wherein said code further comprises instructions for displaying a message when a pointer points upon a field of said electronic dashboard array.

10. The method of claim 1 wherein said electronic dashboard array further comprises a search field and said code comprises instructions for receiving information entered into said search field and for performing a search based on said information.

11. The method of claim 10 wherein said information is selected from a group consisting of a keyword, a fragment of a keyword, a number, an alphanumeric character, a date, and a sign.

12. The method of claim 10 wherein said information is entered by dragging and dropping information into said search field.

13. The method of claim 10 wherein said search comprises defining a two dimensional pointer array indicating columns and rows of said electronic dashboard array that contain said information.

14. A distributed computing system comprising a client machine and a server, wherein said client machine connects to said server via a network connections, downloads a static collection of data and a code from said server, stores said data and said code in a client machine memory and executes executable instructions comprised in said code thereby generating a two dimensional electronic dashboard array for arranging and displaying said data in said electronic dashboard array and wherein said data comprise one or more rows of data in a coma delimited format.

15. The system of claim 14 wherein said code further comprises executable instructions for manipulating said data in said electronic dashboard array via a user input through a client machine user interface and displaying the result of said manipulated data in said electronic dashboard array.

16. The system of claim 14 wherein said code comprises executable instructions written using a combination of a markup language and an object-oriented programming language.

17. The system of claim 16 wherein said markup language is selected from a group consisting of a Hypertext Markup Language (HTML), HTML related markup languages, Extensible Markup Language (XML), XML related languages, XML User Interface Language (XUL), Scalable Vector Graphics (SVG), Xforms, text, and combinations thereof, and said object-oriented programming language is selected from a group consisting of Javascript, Java, J#, C#, C+, C++, Visual Basic, ActionScript, XSL, XQuery, and XPath.

18. The system of claim 14 further comprising a secure login process for login into said server.

19. The system of claim 15 wherein said manipulating of said data comprises operations selected from a group consisting of grouping, filtering, sorting in ascending and descending order, and combinations thereof.

20. The system of claim 14 wherein said executable instructions comprise instructions for generating one or more columns, one or more column formats and one or more column headings, respectively in said electronic dashboard array.

21. The system of claim 20 wherein said coma delimited form data define one or more columns of data and said one or more columns of data are arranged in said one or more columns of said electronic dashboard array, respectively.

22. The system of claim 14 wherein said code further comprises instructions for displaying a message when a pointer points upon a field of said electronic dashboard array.

23. The system of claim 14 wherein said electronic dashboard array further comprises a search field and said code comprises instructions for receiving information entered into said search field and for performing a search based on said information.

24. The system of claim 23 wherein said information is selected from a group consisting of a keyword, a fragment of a keyword, a number, an alphanumeric character, a date, and a sign.

25. The system of claim 23 wherein said information is entered by dragging and dropping information into said search field.

26. The system of claim 23 wherein said search comprises defining a two dimensional pointer array indicating columns and rows of said electronic dashboard array that contain said information.
